(19) United States
(12) Patent Application Publication
(10) Pub. No.: US 2007/0212542 A1
(43) Pub. Date: Sep. 13, 2007

(54) Methods for Preparing and Functionalizing Nanoparticles

(75) Inventors: Bing Guo, College Station, TX (US); Ian M. Kennedy, Davis, CA (US); Dosl Dosev, Davis, CA (US); Darina Meinikov, Carmichael, CA (US); Mikaela Nichkova, Davis, CA (US)

Correspondence Address: FENWICK & WEST LLP, SILICON VALLEY CENTER, 801 CALIFORNIA STREET, MOUNTAIN VIEW, CA, 94041, US

(73) Assignee: The Regents of the University of California

(21) Appl. No.: 10/576,776

(22) PCT Filed: Oct. 22, 2004
(86) PCT No.: PCT/US04/35295

§ 371 Date: Jan. 17, 2007

Related U.S. Application Data
(60) Provisional application No. 60/513,411, filed on Oct. 22, 2003.

(51) Int. Cl. B32B 17/02

(52) U.S. Cl. 428/406; 428/407

(57) ABSTRACT

Fluorescent or phosphorescent nanoparticles, fluorescent or phosphorescent magnetic nanoparticles, combustion-based methods for their synthesis, and methods to functionalize them are described. The methods provided by the invention are simplified, efficient and cost effective as compared to prior art methods. The resulting fluorescent or phosphorescent nanoparticles have reduced tendency toward aggregation, and diminished need for postmanufacturing processing steps. The particles may be manufactured with combinations of lanthanides so as to absorb and emit light over a variety of wavelengths.

### CROSS REFERENCE TO RELATED APPLICATIONS

This application claims the benefit of U.S. Provisional Patent Application Ser. No. 60/513,411, filed Oct. 22, 2003, the entire disclosure of which is incorporated herein by reference.

### STATEMENT REGARDING FEDERALLY SPONSORED RESEARCH OR DEVELOPMENT

The U.S. Government has certain rights in this invention pursuant to Grant No. 5P42ES04699 awarded by the National Institutes of Health and Grant No. 0102662 awarded by the National Science Foundation.

### BACKGROUND OF THE INVENTION

1. Field of the Invention

This invention relates to the fields of chemistry and biology.

2. Description of the Related Art

Fluorescence is a widely used tool in chemistry and biological science. Fluorescent labeling of molecules is a standard technique in biology. The labels are often organic dyes that give rise to the usual problems of broad spectral features, short lifetime, photobleaching, and potential toxicity to cells. A further drawback of fluorescent dye technology is that the conjugation of dye molecules to biological molecules requires a chemistry that generally is unique to each pair of molecules. Alternative labels may be based on lanthanide-derived phosphors. The recent emerging technology of quantum dots has spawned a new era for the development of fluorescent labels using inorganic complexes or particles. These materials offer substantial advantages over organic dyes including larger Stokes shift, longer emission half-life, narrow emission peak and minimal photo-bleaching. However, quantum dot technology still is in its infancy, and is plagued by many problems including difficulties associated with reproducible manufacture, coating, and derivatization of quantum dot materials.

In addition, although the quantum yield of an individual quantum dot is high, the actual fluorescence intensity of each tiny dot is low. Grouping multiple quantum dots into larger particles is one approach for increasing the fluorescence intensity, but this nascent technology still suffers from drawbacks including difficulties in generating and maintaining uniform particle size distributions. Wider application of quantum dot technology therefore has been limited by the difficulties referred to above.

Alternative labels may be based on lanthanide-derived phosphors. Rare-earth metal elements such as europium are known for their unique optical (fluorescent/phosphorescent) properties. When their salts are dissolved in water, their fluorescence is quenched. Thus, many investigators have used europium and other rare-earth chelates to label biological molecules for the sensitive detection of proteins and nucleic acids, to carry out time-resolved fluorometric assays, and as labels in immunoassays. However, this chelation chemistry often is expensive and complex, and so application of rare-earth chelation technology also has been limited to date.

Recently, nanoparticles have received much attention in biology. These particles can have strong fluorescence that exhibits a spectrally sharp emission peak, large Stokes shift, and less quenching influence by other chemicals. Nanoparticles such as Eu₂O₃ particles also have been recognized as offering tremendous potential in obtaining large enhancement of emission intensity. However, Eu₂O₃ and other nanoparticles are easily dissolved by acid during activation and conjugation, thereby losing their desirable properties. In addition, nanoparticles lack reactive groups that allow them to be easily derivatized and linked to analytes and other reagents, thus increasing the difficulty associated with using nanoparticles as labeling reagents for the study of biological and other molecules.

Silica and alumina surfaces have wide-ranging surface reactivities; in particular, silica can be used as a cap to keep europium oxide from dissolving in acid in the conjugation process. However, coating with silica and alumina may increase the particle size, thereby compromising the advantageous properties of nanoparticles that render them suitable as labeling reagents.

Magnetic beads are another type of particle traditionally used in biochemical and clinical analysis for magnetic separation. Usually, they consist of a magnetic core covered by a polymer shell having a functionally modified surface. Particles having magnetic properties and light emitting properties provide additional benefits such as, e.g., permitting optimized biochemical protocols to be developed useful for both analyte detection and analyte separation or purification. U.S. Pat. No. 6,773,812 describes particles having magnetic and light emitting properties, but the light-emitting properties of those particles are derived from conventional dyes such as fluorescent dyes and so suffer from the associated disadvantages of photobleaching, small Stokes shifts, and short lifetimes.

The present invention addresses these and other limitations of the prior art by providing methods for manufacturing and derivatizing nanoparticles, and derivatized nanoparticle compositions that retain the optical properties of the native particles and enable the efficient and low-cost use of the nanoparticles to label and optionally separate or purify biological and other materials.

### SUMMARY OF THE INVENTION

The present invention is defined by the following claims, and nothing in this section should be taken as a limitation on those claims. Disclosed herein are gas-phase flame synthesis methods, apparatus for their synthesis, nanoparticle compositions as well as methods for functionalizing nanoparticles.

Accordingly one aspect of the invention includes a silica glass nanoparticle, co-doped with a rare earth element and another metal element. In another aspect, the invention includes nanoparticles having a magnetic oxide core and a shell comprising a rare earth element and optionally another metal element. In one aspect, the invention includes an apparatus for preparing said nanoparticles by gas-phase combustion and/or pyrolysis synthesis. In another aspect, the invention provides nanoparticles (silica glass nanoparticles and magnetic oxide core particles) comprising a plurality of rare earth elements such as, e.g., Tb and Eu and optionally another metal element. These embodiments provide the additional advantage of absorbing and emitting light at multiple wavelengths further expanding the use of these particles as labels in, e.g., multiplexed applications.

Preferred nanoparticle diameters are in the range of between about 10 and 1000 nm, more preferably between about 10 and 200 nm or between about 10 and 100 nm, and even more preferably between about 20 and 50 nm. The metal oxide particles have the generic formula MeₓO_{y}, wherein 1≦x≦2 and 1≦y≦3 and wherein preferably x=2 and y=3, and wherein preferably, Me is a rare earth element, a lanthanide (atomic number, z, =57 to 71) or an actinide metal (z=89 to 105). In preferred embodiments, Me is selected from the lanthanide series and includes, but is not limited to, europium (Eu), erbium (Er), cerium (Ce), neodymium (Nd), samarium (Sm), terbium (Tb), dysprosium (Dy), gadolinium (Gd), holmium (Ho), or thulium (Tm), or Me may be chromium (Cr), yttrium (Y), or iron (Fe). Other suitable metal oxide particles include silicon oxide (SiO₂), aluminum oxide (Al₂O₃), titanium oxide (TiO₂), and zirconium oxide (ZrO₂) that are mixed with Eu₂O₃ or Eu³⁺.

In other preferred embodiments, the metal oxide particle comprises a doped metal oxide particle by which is meant a metal oxide, and a dopant comprised of one or more rare earth elements. Suitable metal oxides include, but are not limited to, yttrium oxide (Y₂O₃), zirconium oxide (ZrO₂), zinc oxide (ZnO), copper oxide (CuO or Cu₂O), gadolinium oxide (Gd₂O₃), praseodymium oxide (Pr₂O₃), lanthanum oxide (La₂O₃), and alloys thereof. The rare earth element comprises an element selected from the lanthanide series and includes, but is not limited to, europium (Eu), cerium (Ce), neodymium (Nd), samarium (Sm), terbium (Tb), dysprosium (Dy), gadolinium (Gd), holmium (Ho), thulium (Tm), an oxide thereof, and a combination thereof. In these preferred embodiments, the desirable optical property is fluorescence. In another preferred embodiment, the desirable optical property is fluorescence resonance energy transfer (“FRET”). In yet other preferred embodiment, the desirable optical property is phosphorescence.

In another aspect, the invention includes a method for preparing nanoparticles using a gas-phase combustion and/or pyrolysis synthesis. The method comprises a gas-phase flame synthesis process in which, a lanthanide compound or combinations of lanthanide compounds, optionally another metal and optionally a silicon compound are introduced into a flame by entraining the vapor or atomized spray of said materials with a gaseous fuel or entraining the vapor or atomized spray of said materials in a separate gas that mixes with the gaseous fuel prior to entering a reaction zone in which the flame is present. In the reaction zone, the reactants undergo decomposition and/or oxidation reactions to form the corresponding oxides. The hot vapor or atomized spray of the oxides nucleate and condense at lower temperatures to form solid particles. The particles are collected and may be subject to further treatment. The chemical composition of the resulting particles and their physical attributes such as size and shape are controlled by adjusting the relative concentrations of each precursor.

In another aspect, the invention includes a spray flame synthesis process in which previously prepared nanoparticles of iron oxide or other material having magnetic properties are dispersed in a solution comprising lanthanide nitrates such as, e.g., europium nitrate, terbium nitrate, yttrium nitrate, and combinations thereof, etc. The so-formed colloidal solution is sprayed into a flame that preferably is a hydrogen flame. The spray droplets contain solid magnetic particles and liquid solution of lanthanide nitrates. Upon entering the flame, the liquid solution undergoes decomposition and oxidation to form corresponding lanthanide oxide shell on the surface of the magnetic nanoparticles resulting in nanoparticles comprising magnetic cores and a light-emitting shell.

In another aspect the invention includes a method for functionalizing nanoparticles by mixing a functionalizing agent vapor with a humidified aerosol comprising the nanoparticles. Water molecules present on the surface of the nanoparticles facilitates the coating reaction, which results in a layer of free reactive chemical groups on the surface of the particles. The reactive groups permit the particles to be conjugated with, e.g., molecules of biological interest such as proteins, carbohydrates, and nucleic acids. The aerosol containing the particles is introduced in a reaction chamber in which it joins a steady flow of functionalizing agent vapor that may optionally be entrained in an inert carrier gas. The functionalization reaction tales place on the surface of the particles while they are suspended in the reaction chamber. These methods largely avoid the agglomeration problems encountered with liquid-phase functionalization reactions and also greatly reduce or eliminate the need of post-functionalization washing of the particles.

In one embodiment, the compositions of the invention comprise silica, the lanthanide is europium and the at least one other metal is sodium. In a preferred embodiment of the functionalization methods, the functionalization reagent is a silane. Exemplary embodiments include 3-aminopropyltriethoxysilane, 3-aminopropyltrimethoxysilane, as well as mixtures of these or other silanes. Silanes useful for preparing the compositions of the present invention possess a leaving group capable of being displaced by an oxygen present in the metal oxide. Especially preferred leaving groups include C₁-C₄ alkoxides or —OH groups. In a preferred embodiment, the silane also comprises a reactive chemical group through which the stabilized nanoparticle may be bound to a molecule such as a protein, a nucleic acid, a lipid, a carbohydrate or another biological material such as a cell, a tissue sample or other similar materials. Especially preferred reactive chemical groups include primary amino groups, sulfhydryl groups, aldehyde groups, carboxylate groups, alcohol groups, phosphate groups, ester groups and ether groups. Examples of preferred silanes comprising a reactive chemical group include Si(OH)ₙ(O(CH₂)ₚCH₃)ₘ((CH₂)_{q}R), wherein 0≦n≦3; 0≦m≦3; 0≦p≦3; 0≦q≦10, n+m=3, and wherein R═H, halogen, OH, COOH, CHO, NH₂, COOR′, or OR′, (wherein R′ may be an allyl or aryl moiety), SR″ (where R″ is H or a protecting group), or other commonly-used reagents in coupling chemistry. An example of a preferred silane comprising a sulfhydryl functional group (R═SH) is (3-mercaptopropyl)trimethoxysilane (SH(CH₂)₃Si(OCH₃)₃ available as Aldrich cat. no. 17561-7. Preferred silanes bearing a carboxyl functional group (R═COOH) can be prepared from preferred silanes bearing an amino functional group (R═NH₂) (such as, e.g., 3-aminopropyltrimethoxysilane (“APTMS”) H₂N(CH₂)₃Si(OCH₃)₃ (Sigma-Aldrich Chemicals, St. Louis, Mo.)) by reaction with succinic anhydride or glutaric anyhydride. An example of a preferred silane bearing an hydroxyl functional group (R═OH) is 3-glycidoxypropyltrimethoxysilane (Aldrich cat. no. 44016-7).

The invention also provides, in other preferred embodiments, for biological and other molecules derivatized with a metal oxide particle coated with a silane and having a desirable optical property. In one preferred embodiment, the biological molecule is a protein; in another it is a nucleic acid; in yet another it is a lipid; while in another it is a carbohydrate.

The invention also provides for direct assays to specifically detect the presence of an analyte in a sample, comprising specifically binding said analyte in said sample with a biological molecule derivatized with a metal oxide particle manufactured according to a method of the invention and having a desirable optical property, illuminating said particle bound to said analyte, and detecting said desirable optical property as a measure of the presence of said analyte in said sample. In one preferred embodiment, said desirable optical property is fluorescence. In another preferred embodiment, said desirable optical property is phosphorescence. In yet another preferred embodiment said desirable optical property is fluorescent resonance energy transfer (“FRET”). In preferred embodiments in which the metal oxide nanoparticle exhibits long phosphorescent or fluorescent lifetimes (such as, e.g., with lanthanide-containing nanoparticles), said desirable optical property is a fluorescence lifetime or a phosphorescent lifetime. In yet another preferred embodiment said biological molecule is selected from the group consisting of a protein, a nucleic acid, a lipid, and a carbohydrate.

In other preferred embodiments, the invention provides for indirect (i.e., competition) assays to specifically detect the presence of an analyte in a sample, comprising specifically binding an analyte ligand with a biological molecule derivatized with a metal oxide particle coated comprising a functionalizing agent and having a desirable optical property, contacting said bound analyte ligand with a sample comprising an analyte capable of displacing said particle from said analyte ligand, illuminating said particle, and detecting said desirable optical property as a measure of the presence of said analyte in said sample. In one preferred embodiment, said desirable optical property is fluorescence. In another preferred embodiment, said desirable optical property is phosphorescence. In another preferred embodiment said desirable optical property is fluorescent resonance energy transfer (“FRET”). In yet another preferred embodiment said biological molecule is selected from the group consisting of a protein, a nucleic acid, a lipid, and a carbohydrate.

In yet another preferred embodiment, the invention provides for a method for coating a metal oxide particle having a desirable optical property with a silane having a leaving group capable of being displaced by an oxygen present in the metal oxide, comprising contacting said metal particle with said silane, and irradiating said metal particle and said silane with microwave radiation. In preferred embodiments, said silane comprises a chemical group capable of reacting with biological or other molecules. Especially preferred reactive chemical groups include primary amino groups, sulfhydryl groups, aldehyde groups, carboxylate groups, alcohol groups, phosphate groups, ester groups and ether groups.

The invention also provides for a method of derivatizing a molecule with a metal oxide particle made according to the methods of the invention, said particle having a desired optical property and comprising a reactive chemical group, comprising contacting said particle with said molecule under conditions in which said chemical group reacts with said molecule. In preferred embodiments said molecule is a biological molecule selected from the group consisting of a protein, a nucleic acid, a lipid, and a carbohydrate. Especially preferred reactive chemical groups include primary amino groups, sulfhydryl groups, aldehyde groups, carboxylate groups, alcohol groups, phosphate groups, ester groups and ether groups.

### BRIEF DESCRIPTION OF THE SEVERAL VIEWS OF THE DRAWING

These and other features, aspects, and advantages of the present invention will become better understood with regard to the following description, and accompanying drawings, where:

FIG. 1 is a schematic of an apparatus for flame synthesis of nanoparticles.

FIG. 2 is a schematic of a pneumatic nebulizer and optional co-flow jacket used in conjunction with the apparatus illustrated in FIG. 1.

FIG. 3 is a schematic of an apparatus for functionalizing aerosolized nanoparticles.

FIG. 4 Morphology and spectral properties of Eu- and Na-doped silica nanoparticles. FIG. 4A Transmission electron micrograph of Eu- and Na-doped silica nanoparticles. FIG. 4B Fluorescence emission spectra for doped Eu—SiO₂ nanoparticles excited at 466 nm. FIG. 4C Fluorescence emission spectra for doped Eu—SiO₂ nanoparticles excited at 532 nm. Fluorescence lifetime is on the order of 2 msec.

FIG. 5 Morphology and spectral properties of EuSi:ZnO nanoparticles. FIG. 5A Transmission electron micrograph of EuSi:ZnO nanoparticles. FIG. 5B Fluorescence emission spectra for EuSi:ZnO nanoparticles excited at 532 nm. FIG. 5C Fluorescence emission spectra for EuSi:ZnO nanoparticles excited at 532 nm at 466 nm. Fluorescence lifetime is on the order of 4 msec.

FIG. 6 Morphology and spectral properties of Eu₂O₃/SiO₂ nanoparticles. FIG. 6A Transmission electron micrograph of Eu₂O₃/SiO₂. FIG. 6B Fluorescence emission spectra for Eu₂O₃/SiO₂ nanoparticles excited at 466 nm showing fluorescence lifetime on order of 1 msec.

FIG. 7 Morphology and spectral properties of pure Eu₂O₃ nanoparticles (monoclinic phase). FIG. 7A Transmission electron micrograph of pure Eu₂O₃ nanoparticles. FIG. 7B Fluorescence emission spectra for pure Eu₂O₃ nanoparticles (monoclinic phase) excited at 466 nm showing short fluorescence lifetime.

FIG. 8 Morphology and spectral properties of pure Eu:Y₂O₃ nanoparticles. FIG. 7A Transmission electron micrograph of Eu:Y₂O₃ nanoparticles. FIG. 7B Fluorescence emission spectra for pure Eu:Y₂O₃ nanoparticles excited at 260 nm showing fluorescence lifetime on order of 2 msec.

FIG. 9 Fluorescence emission spectra of Tb:Y₂O₃ nanoparticle excited at 260 nm showing fluorescence lifetime on order of 2 msec.

FIG. 10 is a schematic illustrating synthesis, functionalization, and use of nanoparticles in an immunoassay.

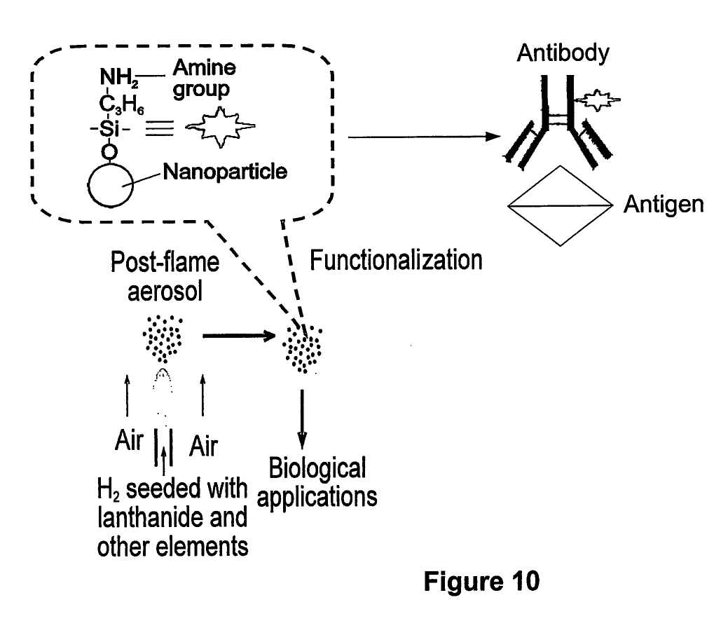

FIG. 11 illustration of use of magnetic rack to separate nanoparticles comprising magnetic cores and light-emitting shells.

### DETAILED DESCRIPTION OF THE PREFERRED EMBODIMENTS

Advantages and Utility

Briefly, and as described in more detail below, described herein are methods, and apparatus for generating and functionalizing lanthanide-containing nanoparticles.

Several features of the current approach should be noted. Gas-phase combustion and/or pyrolysis synthesis methods are used for generating lanthanide-containing nanoparticles. In addition, the particles synthesized using the gas-phase combustion and/or pyrolysis synthesis methods may be functionalized to add chemical groups to the surface by mixing a functionalizing agent vapor with a humidified aerosol comprising the nanoparticles. Particles also may be functionalized by incubation in a solution comprising a biological molecule such as, e.g., a protein, a carbohydrate, a lipid and a nucleic acid, or a polyionic polymer such as, e.g., poly-L-lysine or poly-L-lysine hydrobromide, PL.

Advantages of this approach are numerous. One advantage provided by the invention is a simple and low-cost single-step process to produce nanoparticles that are more uniform and less prone to aggregation than those produced using prior art methods such as ball milling or solution phase syntheses. The functionalization methods disclosed also are simple and low-cost and result in high quality nanoparticles. The functionalization method largely avoids the agglomeration problem encountered with similar procedures that take place in the liquid phase, and greatly reduces or eliminates the need for post-functionalization washing of the nanoparticles. Because the spectral properties of the nanoparticles of the present invention do not depend on the particle diameter, the size distribution of a population of the particles need not be monodisperse. This provides advantages in ease of manufacturing as compared to the manufacture of quantum dots whose spectral properties are a function of particle diameter.

The invention provides methods, apparatus and compositions for generating and functionalizing lanthanide-containing nanoparticles that have utility as labels in various applications such as, e.g., immunoassays and nucleic acid based diagnostics.

In general, the nanoparticle compositions of the present invention comprise a metal oxide particle having a desirable optical property that has been coated with a functionalizing reagent. The functionalizing reagent may comprise a silane as disclosed in co-owned pending U.S. Patent Publication 2003/0180780, incorporated herein by reference for all purposes, or comprise a protein or peptide such as, e.g., BSA or an immunoglobulin, or may be a polyionic polymer, such as, e.g., (poly-L-lysine hydrobromide, PL).

Preferred particle diameters are in the range of between about 10 and 1000 nm, more preferably between about 10 and 200 nm and even more preferably between about 10 and 100 nm, or between about 20 and 50 nm. In preferred embodiments, the metal oxide particles have the generic formula MeₓO_{y} wherein 1≦x≦2, and 1≦y≦3, and wherein preferably, Me is a rare earth element selected from the lanthanide series and includes, but is not limited to, europium (Eu), cerium (Ce), neodymium (Nd), samarium (Sm), terbium (Tb), dysprosium (Dy), gadolinium (Gd), holmium (Ho), thulium (Tm), or Me may be chromium (Cr), yttrium (Y), iron (Fe). Other suitable metal oxide particles include silicon oxide (SiO₂), and aluminum oxide (Al₂O₃) mixed with Eu₂O₃ or Eu³⁺.

In other preferred embodiments, the metal oxide particle comprises a doped metal oxide particle by which is meant a metal oxide, and a dopant comprised of one or more rare earth elements. Suitable metal oxides include, but are not limited to, yttrium oxide (Y₂O₃), zirconium oxide (ZrO₂), zinc oxide (ZnO), copper oxide (CuO or Cu₂O), gadolinium oxide (Gd₂O₃), praseodymium oxide (Pr₂O₃), lanthanum oxide (La₂O₃), and alloys thereof. The rare earth element comprises an element selected from the lanthanide series and includes, but is not limited to, europium (Eu), cerium (Ce), neodymium (Nd), samarium (Sm), terbium (Tb), gadolinium (Gd), holmium (Ho), thulium (Tm), an oxide thereof, and a combination thereof. Nanoparticles of such oxides may be manufactured according to the methods of the present invention, purchased from commercial suppliers, or fabricated using methods known to those of ordinary skill in the art as set forth in, e.g., references 26 and 35, the disclosures of which are herein incorporated by reference.

The desirable optical properties of the compositions of the present invention include optical properties that allow the compositions to be useful as labeling agents, such as, e.g., fluorescence, fluorescence resonance energy transfer (“FRET”), and phosphorescence. Thus, the compositions of the present invention may be used by one of skill in the art in the same manner as fluorescent dyes, FRET pairs and other labeling reagents, but with the advantages that nanoparticles bring to labeling technology in terms of larger Stokes shift, longer emission half-life (for lanthanide-containing nanoparticles), diminished emission bandwidth, and less photobleaching as compared with, e.g., traditional fluorescent dyes.

In addition to surface modification methods disclosed in co-pending U.S. Patent Application Publication 2003/0180780, incorporated herein by reference in its entirety, additional methods may be used in the practice of the invention for surface modification (i.e., functionalization) and conjugation of the nanoparticles of the invention. In one embodiment, surface modification and conjugation comprises direct coating of the nanoparticles with a protein such as, e.g., BSA, ovalbumin or immunoglobulin. In another embodiment, surface modification is accomplished by physical adsorption and functionalizing with a polyionic polymer such as, e.g., poly-L-lysine hydrobromide, PL.

Using appropriate buffer conditions (pH and concentration), a variety of proteins can be adsorbed spontaneously on the surface of the nanoparticles without affecting their fluorescence properties. The protein coated particles are purified by 3 rounds of centrifugation and are stable for more than 1 month in buffer solution. Adsorption of bovine serum albumin (BSA) provides multiple functional groups (amine, carboxylic) for covalent conjugation to other biomolecules using standard cross-linking procedures. If BSA-biotin is used as a coating protein, biotinylated particles are produced for a variety of applications in bioassays. If the particles are coated with BSA-hapten (small molecule), such as the coating antigens commonly used in ELISA, the modified particles may be used as fluorescent competitors in immunoassays. The nanoparticles are efficiently coated with immunoglobulin molecules, preserving the functionality of the nanoparticles and the functionality and activity of the immunoglobulins. The number of binding sites (biotin, hapten, antibody) may be controlled during the coating procedure by mixing a specific protein (i.e., the protein providing the binding site) and a non-specific blocking protein (i.e., one that does not provide a binding site) in different ratios. Blocking proteins are well-known to those in the biochemical arts and include, e.g., BSA, casein, milk proteins, and other agents useful for blocking non-specific binding in biochemical reactions such as, e.g., ligand binding assays, Western blots, ELISAs, etc. Examples of pairs of specific proteins and non-specific blocking proteins include, e.g. BSA-biotin:BSA, specific anti-rabbit IgG:non-specific sheep IgG. The blocking protein prevents possible non-specific binding of the nanoparticles to other proteins and/or surfaces during the performance of bioassays improving in this way the signal/noise ratio.

PL is a polycationic polymer that adsorbs spontaneously from aqueous solutions onto the negatively charged metal oxide surfaces via electrostatic interactions. The excess of PL is washed off by centrifugation. The formed layer of PL is stable under the most commonly used buffers. The introduced amino groups on the surface of the particles permit their conjugation to a variety of small molecules (haptens) and biomolecules with appropriate functionalizations.

Definitions

It must be noted that, as used in the specification, the singular forms “a,” “an” and “the” include plural referents unless the context clearly dictates otherwise.

Materials and Methods of the Invention

Table 1 provides a non-limiting listing of the reagents, abbreviations for the reagents, formulae, suppliers, form of usage of the reagent in the described syntheses and examples of alternative reagents useful for practicing the methods of the invention. The listing is intended to be exemplary and to provide guidance to an ordinarily skilled artisan as to other materials useful for practice of the invention. Those materials are readily ascertained by the ordinarily skilled artisan provided with the teachings of this specification.

TABLE 1
Exemplary Reagents

| | | | Form of Usage | |
|---|---|---|---|---|
| Reagent | Formula | Supplier | in Synthesis | Substitute Reagent |
| Tris(2,2,6,6-tetramethyl-3,5- | | Alfa Aesar, | Vapor at 200 C. | Europium metal, any europium |
| heptanedionato) europium(III) | | Ward Hill, MA | | compound that has sufficient |
| abbreviated as Eu(TMHD)₃ | | | | vapor pressure at 200 C. and |
| | | | | does not decompose below 400 C. |
| Sodium metal | Na | | Vapor at 400 C. | Other alkali or alkaline |
| | | | | earth metals |
| Zinc metal | Zn | | Vapor at 400 C. | Other alkali or alkaline |
| | | | | earth metals |
| Europium (III)nitrate | Eu(NO₃)₃•6H₂O | Alfa Aesar, | Aqueous solution or | Other soluble europium salts, |
| | | Ward Hill, MA | solution in an organic | such as EuCl₃, that does not |
| | | | solvent that is | negatively affect the |
| | | | readily nebulizable | synthesis reactions |
| Ytrium (III)nitrate | Y(NO₃)₃•6H₂O | Alfa Aesar, | Same as above | Other soluble europium salts, |
| | | Ward Hill, MA | | such as YCl₃, that does not |
| | | | | negatively affect the |
| | | | | synthesis reactions |
| Terbium (III)nitrate | Tb(NO₃)₃•6H₂O | Alfa Aesar, | Same as above | Other soluble europium salts, |
| | | Ward Hill, MA | | such as TbCl₃, that does not |
| | | | | negatively affect the |
| | | | | synthesis reactions |
| Hexamethyldisiloxane | C₆H₁₈OSi₂ | Sigma Aldrich, | Both as the vapor and | Any other organic compound that |
| abbreviated as HMDS | | St. Louis, MO | a solution in an | contains silicon and has |
| | | | organic solvent, such | sufficient vapor pressure at |
| | | | as ethanol, that is | room temperature and is soluble |
| | | | readily atomizable | in the solvent used for |
| | | | | dissolving the other starting |
| | | | | materials that does not |
| | | | | negatively affect the synthesis |
| | | | | reactions |
| (3-Aminopropyl)triethoxysilane | | Sigma Aldrich, | Vapor at room | Many other silanizing reagents. |
| abbreviated as APTES | | St. Louis, MO | temperature | |
| (3-Aminopropyl)trimethoxysilane | | Sigma Aldrich, | Vapor at room | Many other silanizing reagents. |
| abbreviated APTMS | | St. Louis, MO | temperature | |
| Iron(III) nitrate | Fe(NO₃)₃•9H₂O | Sigma Aldrich, | Aqueous solution or | Other soluble iron salts such |
| | | St. Louis, MO | solution in readily- | as FeCl₃. |
| | | | nebulizable organic | |
| | | | solvent | |
| Bovine serum albumin (BSA) | | Sigma Aldrich, | Aqueous solution | Modified BSA such as, e.g. |
| | | St. Louis, MO | | biotinylated BS or BS conjugated |
| | | | | to small molecules or haptens; |
| | | | | other proteins such as, e.g., |
| | | | | ovalbumin |
| Anti-rabbig IgG | | Sigma Aldrich, | Aqueous solution | Other antibodies such as, e.g., |
| | | St. Louis, MO | | rabbit immunoglobulin, sheep |
| | | | | immunoglobulin, anti-sheep |
| | | | | immunoglobulin; immunoglobulin |
| | | | | class is not critical and so |
| | | | | can use IgG, IgA, IgM, etc.; |
| | | | | antibody fragments, single |
| | | | | chain antibody fragments |
| | | | | (scFvs), etc. |
| Poly-L-lysine hydrobromide | H₃N— | Sigma Aldrich, | Aqueous solution | Other polycationic polymers |
| | CH(CH₂)4NH₃Br— | St. Louis, MO | | comprising a leaving group |
| | [CO—NH— | | | |
| | CH(CH₂)4NH₃Br]— | | | |
| | COO⁻ | | | |
| Fluorescein isothiocyanate | | Sigma Aldrich, | Aqueous solution | Other fluorescent dyes |
| (FITC) | | St. Louis, MO | | |

### EXAMPLES

Below are examples of specific embodiments for carrying out the present invention. The examples are offered for illustrative purposes only, and are not intended to limit the scope of the present invention in any way. Efforts have been made to ensure accuracy with respect to numbers used (e.g., amounts, temperatures, etc.), but some experimental error and deviation should, of course, be allowed for.

The practice of the present invention will employ, unless otherwise indicated, conventional methods of protein chemistry, biochemistry, recombinant DNA techniques and pharmacology, within the skill of the art. Such techniques are explained fully in the literature.

See, e.g., T. E. Creighton, Proteins: Structures and Molecular Properties (W.H. Freeman and Company, 1993); A. L. Lehninger, Biochemistry (Worth Publishers, Inc., current addition); Sambrook, et al., Molecular Cloning: A Laboratory Manual (2nd Edition, 1989); Methods In Enzymology (S. Colowick and N. Kaplan eds., Academic Press, Inc.); Remington's Pharmaceutical Sciences, 18th Edition (Easton, Pa.: Mack Publishing Company, 1990); Carey and Sundberg Advanced Organic Chemistry 3^{rd} Ed. (Plenum Press) Vols A and B(1992).

Methods

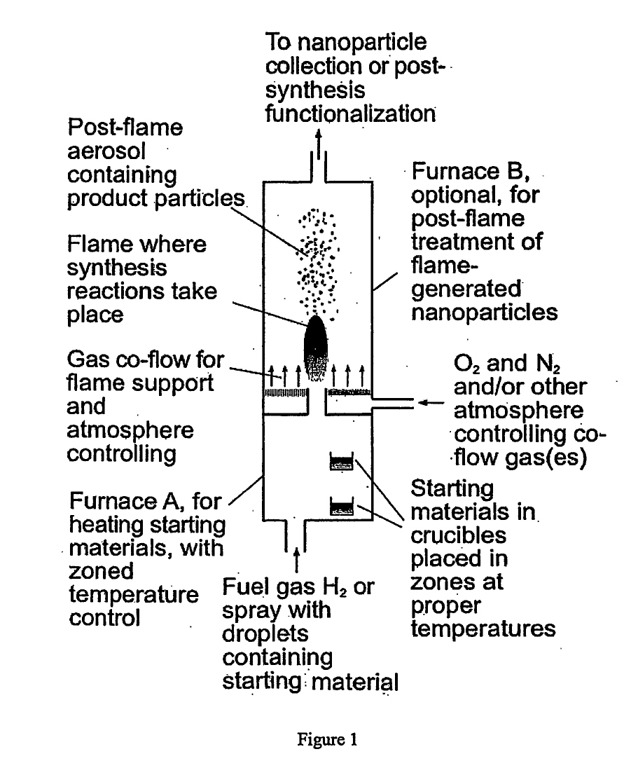

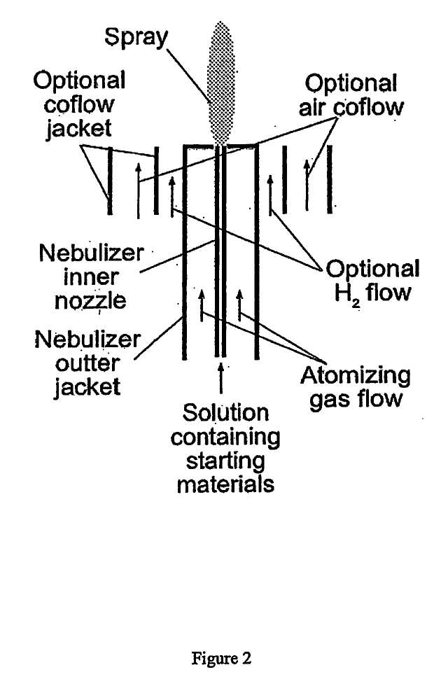

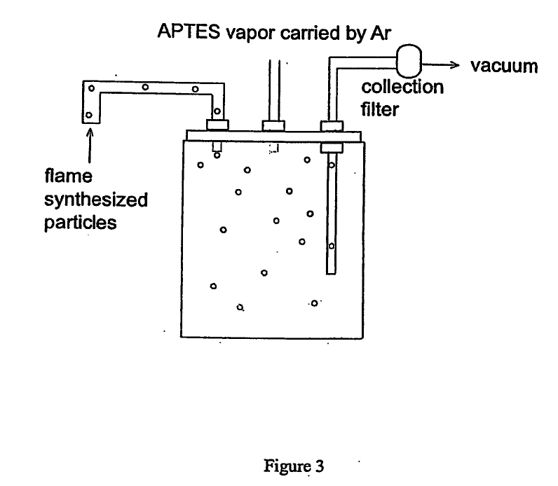

The syntheses have been conducted in a manner that involves a flame as the reaction zone, utilizing an apparatus illustrated in FIG. 1 and FIG. 2, or a combination of the two. Functionalization has been carried out using the apparatus illustrated in FIG. 3, with an aerosol containing nanoparticles produced by the described syntheses as targets for functionalization.

Based on the different forms of usage of the starting materials, the syntheses can be divided into two classes, gas-phase synthesis in which all the starting materials are fed into the flame in the vapor phase, and, spray-pyrolysis synthesis in which one or more of the starting materials is fed into the flame in the form of droplets containing the starting material, or solid particles derived from the droplets. The functionalization methods of the present invention may be practiced with nanoparticles synthesized using the disclosed gas-phase combustion and/or pyrolysis synthesis method disclosed herein, or with nanoparticles produced using other manufacturing techniques.

### Example 1

### Gas-Phase Synthesis of Eu:Na:Si Nanoparticles

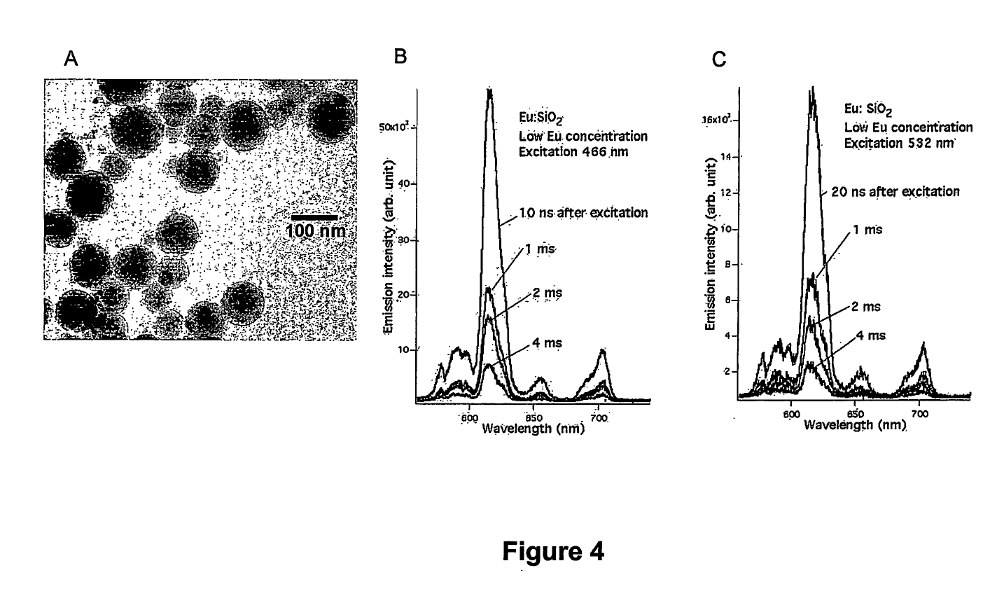

50 mg Eu(TMHD)₃ and 1 g metal sodium were placed in furnace A shown in FIG. 1, in zones at 200° C. and 400° C., respectively. Pure H₂ was introduced into furnace A at 0.2 standard Liter/min through the inlet at bottom. Another stream of H₂, after passing through a cartridge containing pure HMDS kept at 23° C. and entraining saturated vapor of HMDS, was also introduced into furnace A. The two streams of H₂ mixed within furnace A and entrained the saturated vapors of the metal sodium and Eu(TMHD)₃ at their corresponding temperatures. The H₂ containing all the starting materials was ignited at the outlet of furnace A in 1 atmosphere air. The maximum temperature in the flame was about 2130° C. The starting materials decomposed in the flame, formed corresponding oxides, and further formed silica glass nanoparticles that contain europium. The particles were determined by transmission electron microscopy to be spherical and not aggregated. FIG. 4, left panel is a transmission electron micrograph showing size and morphology of particles synthesized using the approach outlined in this example, except that only trace amounts of Eu (carried over from an earlier synthesis) were present. The Eu:Na:Si atomic ratio of the product nanoparticles synthesized in this example was about 1:20:100 as determined by a Philips CM-12 Transmission Electron Microscope equipped with an Oxford Instruments EDX detector for elemental analysis. The particles exhibited strong fluorescence and fluorescence lifetime is about 2 msec. (Data not shown). Right hand panel in FIG. 4 illustrates fluorescence emission spectra for particles synthesized in a manner similar to those described above, except no Na metal was included during the synthesis. Top panel shows emission spectrum using 466 nm excitation wavelength and bottom panel shows emission spectrum using 532 nm excitation wavelength. Fluorescence lifetime was on the order of 2 msec.

Adjusting the heating temperature for the starting materials that require heating, and the flow rate of the carrier gas for HMDS, allows the fine tuning of the atomic ratios of the elements in the nanoparticles.

### Example 2

### Gas-Phase Synthesis of Eu:Zn:Si Nanoparticles

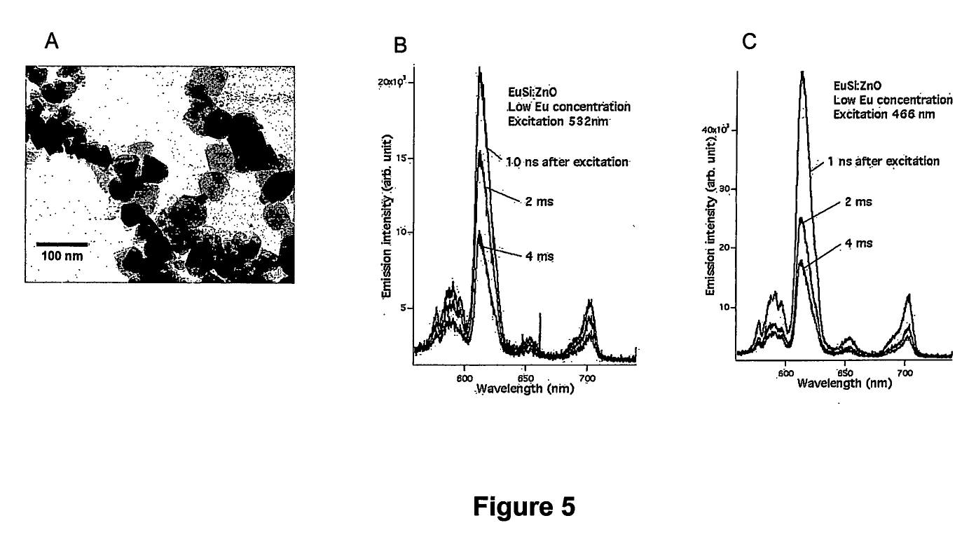

Methods were the same as those described in Example 1, except that Zn metal was substituted for the Na metal, and trace amounts of Eu were present (carried over from an earlier synthesis). FIG. 5 left panel is a transmission electron micrograph illustrating the size and morphology of the nanoparticles made in Example 2. The middle and right hand panels of FIG. 5 illustrate fluorescence emission spectra of the nanoparticles excited at 532 nm (middle panel) and at 466 nm (right hand panel), showing fluorescence lifetime on the order of 4 msec.

### Example 3

### Gas-Phase Synthesis of Eu:Si Nanoparticles

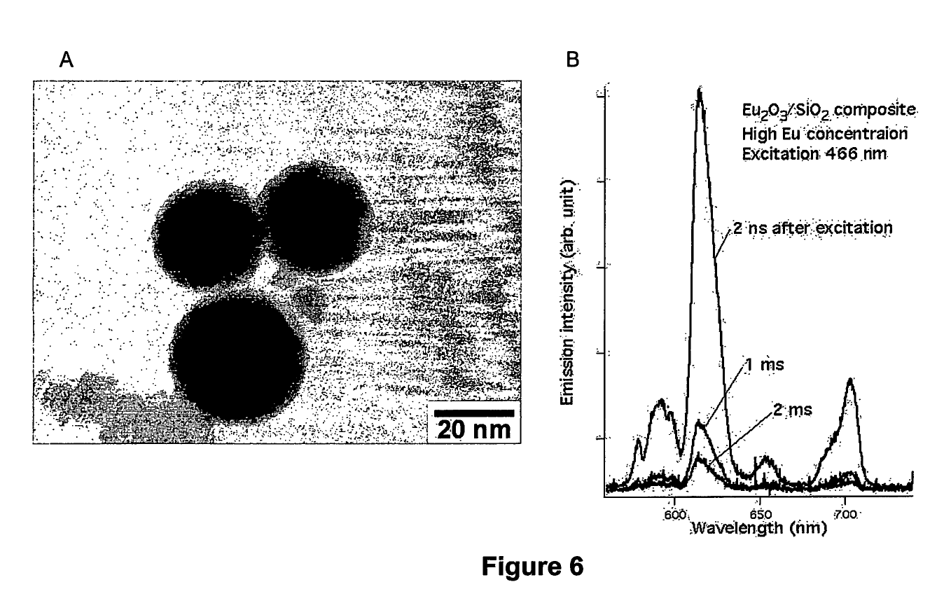

The synthesis conditions were the same as those described in Example 1, except sodium metal was not used. Pure O₂ co-flow was used surrounding the outlet of furnace A, by mounting an optional co-flow jacket, as shown in FIG. 2. The flame temperature was about 2400° C. A transmission electron micrograph showing the size and morphology of the resulting nanoparticles is shown in the left panel of FIG. 6. A fluorescence emission spectrum of the resulting nanoparticles is shown in the right panel of FIG. 6. The excitation wavelength was 466 nm, fluorescence lifetime was on the order of 1 msec.

### Example 4

### Gas-Phase Synthesis of Eu Nanoparticles

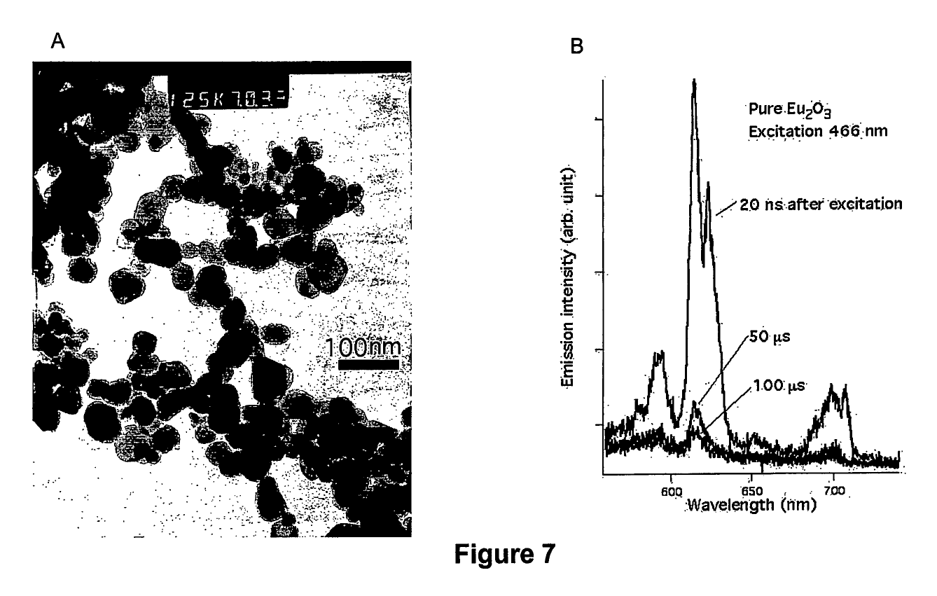

The synthesis conditions were essentially the same as those described in Example 1, except that only Eu(TMHD)₃ was placed in furnace A. The material was heated to 200° C. and entrained in a stream of H₂ gas. The H₂ containing the starting materials was ignited at the outlet of furnace A in 1 atmosphere air. The maximum temperature in the flame was about 2130° C. The starting material decomposed in the flame, formed the corresponding oxide (i.e., Eu₂O₃). FIG. 7, left panel is a transmission electron micrograph of the material synthesized in this example, showing the size and morphology of the nanoparticles. Powder diffraction analysis revealed that the resulting crystals are monoclinic. Right panel of FIG. 7 is a fluorescence emission spectrum using an excitation wavelength of 466 nm. The fluorescence lifetime is short due to the small size of the nanoparticles and concentration quenching.

### Example 5

### Spray-Pyrolysis Synthesis of Eu:Y Nanoparticles

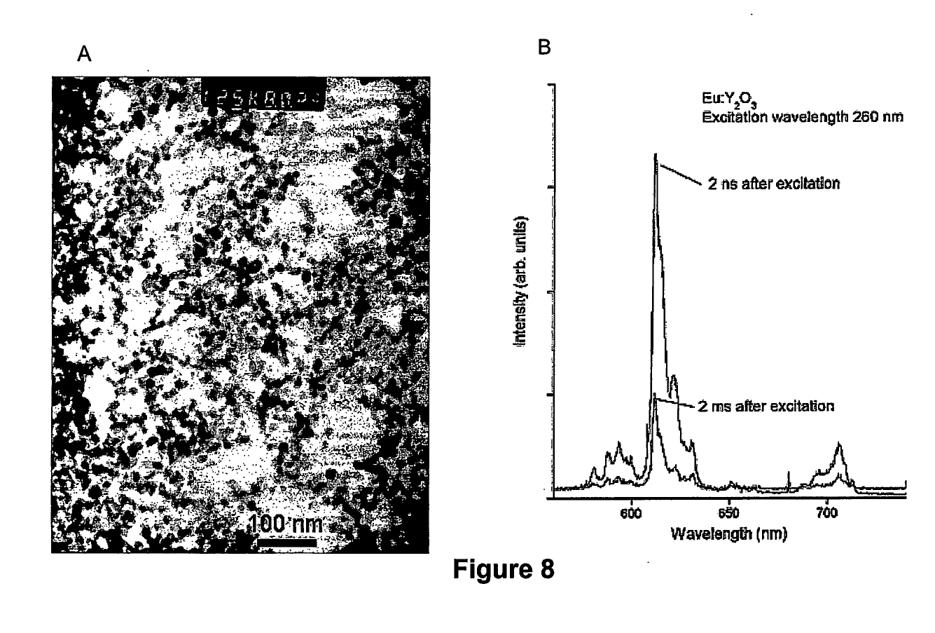

An ethanol solution containing 1 mM Eu(NO₃)₃ and 30 mM Y(NO₃)₃ was pumped with a syringe pump (Cole-Parmer, Vernon Hills, Ill.) at 7 mL/h into the inner nozzle of the nebulizer illustrated in FIG. 2. Ar gas, at 2 standard Liter/min, flowed through the annular gap surrounding the inner nozzle and atomized the ethanol solution containing the starting materials. The solution was atomized to form a spray at the tip of the nebulizer. The nebulizer was combined with an optional co-flow jacket, which supplied H₂ at 2 standard Liter/min and co-flowed air at 10 standard Liter/min, to form a hydrogen diffusion flame surrounding the outlet of the nebulizer. Flame temperature was about 2100° C. The H₂ diffusion flame ignited the spray formed by the nebulizer and reactions took place within the flame to form Eu:Y₂O₃ nanoparticles that have desired chemical composition, size and morphology. FIG. 8 left panel shows a transmission electron micrograph of the resulting nanoparticles. The right panel of FIG. 8 shows a fluorescence emission spectrum using an excitation wavelength of 260 nm. Particles have a fluorescence lifetime on the order of 2 msec.

In an alternate method, the spray generated by the nebulizer can be introduced into furnace A, along with 2 standard Liter/min H₂. The spray then is preheated in furnace A to remove the solvent from the droplets, to form an aerosol containing dry particles. This aerosol can be ignited at the outlet of furnace A to form a diffusion flame, in which the synthesis reactions take place. Post-synthesis treatment of the nanoparticles produced by the spray-pyrolysis synthesis is optional with furnace B. Post-synthesis treatment helps to remove impurities and improve the crystallographic properties of the nanoparticles formed in the flame. In addition to ethanol, other solvents useful for spray pyrolysis include aqueous ethanol, water, acetone or other lower alcohols, ketones, or any other solvent in which the reagents are stable for the time necessary to carry out the synthesis, and that have a density and molecular weight appropriate to allow atomization of the reagents.

### Example 6

### Spray-Pyrolysis Synthesis of Tb:Y Nanoparticles

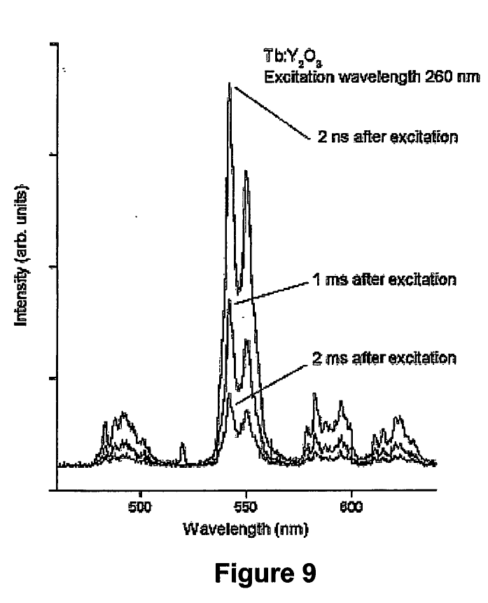

Conditions were the same as those described in Example 5, except that Eu(NO₃)₃ was replaced by Tb(NO₃)₃. The fluorescence emission spectrum of the resulting particles is shown in FIG. 9. Excitation wavelength was 260 nm; fluorescence lifetime was on the order of 2 msec.

### Example 7

### Functionalization of Nanoparticles

Functionalization is carried out using the apparatus illustrated in FIG. 3. 4 ml of 3-aminopropyltriethoxy-silane (APTES) is contained in a 250 ml Erlenmeyer flask (not shown) having one inlet and one outlet, T=20° C., P=1 atm. Ar gas is used as a carrier gas to deliver APTES vapor into the reaction chamber of FIG. 3. Various flow rates of Ar are used: 50 SCCM, 75 SCCM, 100 SCCM, 150 SCCM.

The reaction chamber contains two inlets and one outlet. Nanoparticles are collected with a probe located 2-5 cm from the burner illustrated in FIG. 1. The flow rate of the combustion products gas into the chamber is determined by the vacuum suction rate. In the chamber, APTES vapor mixes with particles. The concentration of water in the aerosol plays an important role in the amino-silane coating of the target nanoparticles within. The presence of water molecule on the surface of the nanoparticles facilitates the binding of the amino-silane molecules with the particles surface. However, excess amounts of water cause cross-linking between the amino-silane molecules and render them useless or even detrimental to the coating process. Hence there is an optimal water vapor concentration for each functionalization process. In the case where nanoparticles are functionalized by coating with (3-Aminopropyl)triethoxysilane freshly from the gas-phase flame synthesis process, the water vapor is originated from the combustion of H₂ and its concentration in the aerosol is adjusted by dilution from the air co-flow assisting the combustion process. The water content in this aerosol is about 0.02 g/Liter, providing effective functionalization of these particles by APTES. The particle concentration in the aerosol is on the order of 106 particles/cm³, with a typical mean diameter of 50 nm.

Functionalized particles are collected on the anodisc 47 Whatman filter.

### Example 8

### Conjugation and Use of Functionalized Nanoparticles

Nanoparticles functionalized according to the method described in Example 7 have a free amino group that is used to conjugate the particle to a biomolecule such as an antibody using techniques known to those of ordinary skill in the art. The labeled antibody is used in an immunoassay to detect the presence of an analyte in a sample suspected of containing the analyte. Such methods also are well known to those of ordinary skill in the art.

### Example 9

### Surface Modification of Nanoparticles with Immunoglobulin

0.5 mg nanoparticles were suspended in 1 ml of 25 mM phosphate buffer pH=7.5 in a polypropylene tube. 100 μl of 2 mg/ml solution of antibody (e.g. anti-rabbit IgG) were added. The suspension was incubated in a round mill flask overnight at room temperature. On the following day the suspension was centrifuged, the supernatant discarded and the nanoparticle pellet resuspended in the same buffer for washing off the excess of the protein. This procedure was repeated 3 times. The coated particles were stored in PBS buffer. The surface saturation capacity of the nanoparticles and the stability of the conjugate were evaluated by detection of the active binding sites on the surface via rabbit IgG-fluorescein and by determination of the protein concentration in the supernatant.

### Example 10

### Surface Modification of Nanoparticles with BSA

Conditions were the same as those described in Example 9, except that IgG was replaced by BSA (BSA-biotin or BSA-hapten).

### Example 11

### Surface Modification of Nanoparticles with Poly-L-Lysine Hydrobromide (PL)

0.5 mg nanoparticles were suspended in 0.5 ml of water in a polypropylene tube. 500 μl of 20 mg/ml solution of PL were added. The suspension is incubated in a round mill for 2 hours at room temperature. The excess of PL was removed by centrifugation and resuspension of the nanoparticles in water. This procedure was repeated 3 times. The number of reactive amino groups was quantified by interaction with fluorescein isothiocianate.

### Example 12

### Spray Pyrolysis of Fe₃O₂/Eu:Y₂O₃ (Magnetic Core/Fluorescent Shell) Nanoparticles

This method includes two steps of synthesis. In the first step, Fe₂O₃ nanoparticles were synthesized. In the second step, the Fe₂O₃ nanoparticles were dispersed in a solution containing precursors for the synthesis of fluorescent Eu:Y₂O₃ as in Example 5.

Step 1. Spray Pyrolysis Synthesis of Fe₂O₃ Nanoparticles

Conditions were the same as those described in Example 5, except that 30 mM Fe(NO₃)₃ ethanol solution was prepared and used instead of the 1 mM Eu(NO₃)₃ and 30 mM Y(NO₃)₃ solution of Example 5.

Step 2. One mg Fe₂O₃ nanoparticles per 50 ml were added to an ethanol solution of Eu(NO₃)₃ and 30 mM Y(NO₃)₃. The rest of the conditions were the same as in Example 5.

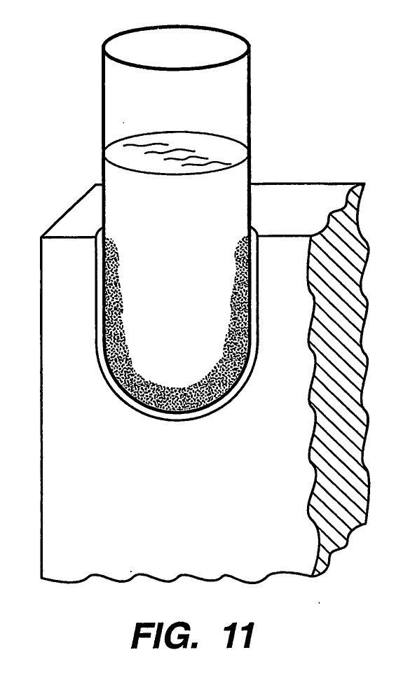

The fluorescent spectrum of the obtained nanoparticles was identical with the spectrum shown in FIG. 8. FIG. 11 is an illustration of the magnetic properties of the obtained nanoparticles as they are suspended in water and subjected to a magnetic field. The particles stick to the left and the right walls of the glass test tube due to the magnetic attraction of the external magnet. The rest of the solution can be then pulled out of the tube and separated from the particles.

The foregoing description of the embodiments of the invention has been presented for the purposes of illustration and description. It is not intended to be exhaustive or to limit the invention to the precise forms disclosed. Persons skilled in the relevant art can appreciate that many modifications and variations are possible in light of the above teaching. Concentrations, sizes and other parameters stated in the specification and the claims are for example only and are intended to include variations consistent with the practice of the present invention. Such permissible variations are readily determined by persons of skill in the art in light of the instant disclosure and typically encompass between about +10% to about +20% of the stated parameter. It is therefore intended that the scope of the invention be limited not by this detailed description, but rather by the claims appended hereto. References to publications, patent applications and issued patents contained in this specification are herein incorporated by reference in their entirety for all purposes.

1. A composition, comprising:
a nanoparticle consisting essentially of a rare earth element doped in a metal oxide, wherein the surface of said nanoparticle is functionalized with a biological molecule or a polyionic polymer, and wherein said nanoparticle is capable of light emission.

2. A composition, comprising:
a silica glass nanoparticle consisting essentially of a first metal oxide and optionally a second metal oxide, wherein the surface of said nanoparticle is functionalized with a biological material or a polyionic polymer, and wherein said nanoparticle is capable of light emission.
